(19) United States
(12) Patent Application Publication
(10) Pub. No.: US 2012/0057857 A1
(43) Pub. Date: Mar. 8, 2012

(54) TANKLESS LIQUID HEATER USING A THERMOSTATIC MIXING VALVE

(76) Inventors: Joseph Kevin Kenney, Bethel, CT (US); Jeff Hankins, Southbury, CT (US)

(21) Appl. No.: 12/875,583

(22) Filed: Sep. 3, 2010

(51) Int. Cl. F24H 1/10; H05B 1/02; G05D 23/185

(52) U.S. Cl. 392/465; 236/12.11; 219/494

(57) ABSTRACT

In various aspects, the present application describes a tankless liquid heater receiving liquid at an inlet and providing heated liquid at an outlet. The tankless liquid heater may include a heating element for heating liquid received from the inlet. A flow sensor indicates the flow rate of the liquid received by the heating element. The heater includes a temperature sensor measuring the temperature of liquid exiting the heating element. A controller of the heater regulates the amount of electrical current energizing the heating element responsive to the flow sensor and the temperature sensor, energizes the heating element when the flow rate of the liquid exceeds a predefined value and prevents energizing the heating element when the heated liquid exceeds a predefined temperature. The heater may also include a thermostatic mixing valve for mixing the heated liquid with liquid diverted from the inlet responsive to the temperature of the heated liquid.

### FIELD OF THE DISCLOSURE

This disclosure generally relates to systems and methods for heating liquids. In particular, this disclosure relates to tankless liquid heating systems using a thermostatic mixing valve.

### BACKGROUND

A common approach for providing hot water in both domestic and commercial settings involves the use of large tanks for the storage of hot water. Although such heated tank systems can provide hot water at a relatively high flow rate, they are inherently energy inefficient because the water in the tank is continually reheated even when water is not being used on a regular basis. Another approach to providing hot water involves the use of a tankless water heater system that heats water only when hot water is being used. Such tankless water heater systems, also referred to as demand water heater systems, can often provide a more energy efficient means of heating water than storage systems using the same type of heating (e.g., gas, electric, etc.).

### SUMMARY OF THE DISCLOSURE

In various aspects, the present disclosure describes embodiments of a tankless liquid heating system incorporating a mixing valve. Some embodiments of such a heating system may be installed for providing heated or tempered water for various uses, such as emergency rinsing at safety showers, hand-washing at wash stations, providing drinking water from dispensers, and so on. The heating system includes a controller that energizes a heating element based on the flow of liquid through the heating element, and the temperature of the heated liquid leaving the heating element. A thermostatic mixing valve is incorporated into the heating system, which can provide tempered liquid by mixing heated liquid with cold liquid diverted from a liquid inlet of the heating system. The thermostatic mixing valve may be configured to mix liquid responsive to a temperature set point applied on one or more of a temperature sensor and a controller of the heating system. In some embodiments, the heating system is configured to provide heated or tempered liquid free from temperature spikes that may cause injury or discomfort to a user.

In one aspect, the present invention is related to a tankless liquid heater receiving liquid at an inlet and providing heated liquid at an outlet. The tankless liquid heater may include a heating element for heating liquid received from the inlet of the liquid heater. The tankless liquid heater may include a flow sensor indicating the flow rate of the liquid received by the heating element. The tankless liquid heater may include a temperature sensor measuring the temperature of liquid exiting the heating element. The tankless liquid heater may include a controller regulating the amount of electrical current energizing the heating element responsive to the flow sensor and the temperature sensor. The controller may energize the heating element when the flow rate of the liquid exceeds a predefined value and may prevent energizing the heating element when the heated liquid exceeds a predefined temperature T1. The tankless liquid heater may include a thermostatic mixing valve for mixing the heated liquid with liquid diverted from the inlet responsive to the temperature of the heated liquid.

In some embodiments, the thermostatic valve mixes liquid diverted from the inlet with the heated liquid when the temperature of the heated liquid is at least about 5 degrees Fahrenheit above temperature T1. The thermostatic valve may mix liquid diverted from the inlet with the heated liquid when the temperature of the heated liquid is at least a predefined number of degrees Fahrenheit, D1, above temperature T1. The thermostatic mixing valve may output liquid at a temperature deviating from T1 by less than about (D1+2) degrees Fahrenheit. The thermostatic valve may mix liquid diverted from the inlet with the heated liquid when the temperature of the heated liquid is above a predetermined value. The thermostatic valve may mix liquid diverted from the inlet with the heated liquid when the temperature of the heated liquid is above about 110 degrees Fahrenheit. The thermostatic mixing valve may mix the liquid diverted from the inlet with the heated liquid at a sufficiently fast rate to prevent a person in contact with the mixed water from being scalded. In certain embodiments, the thermostatic mixing valve outputs liquid having a temperature between about 90 to 105 degrees Fahrenheit. In one embodiment, the thermostatic mixing valve outputs liquid with a temperature upper limit of about 110 degrees Fahrenheit.

In some embodiments, the thermostatic mixing valve outputs liquid with a preconfigurable temperature upper limit. The thermostatic mixing valve may output heated liquid at a flow rate of at least about 0.3 gallons per minute. The thermostatic mixing valve may output heated liquid at a flow rate of about 0.3 gallons per minute to about 5.0 gallons per minute. In certain embodiments, the thermostatic mixing valve mixes the heated water with liquid diverted from the inlet when the flow rate of the liquid received by the heating element falls substantially over a short period of time. In some embodiments, the thermostatic mixing valve mixes the heated water with liquid diverted from the inlet when the flow rate of the liquid received by the heating element falls substantially instantaneously. The thermostatic mixing valve may support a liquid flow rate equal or higher than that supported by the heating element. The thermostatic mixing valve may divert a substantial amount of liquid from the inlet within a short amount of time for mixing with the heated liquid responsive to the temperature of the heated liquid.

In some embodiments, the tankless liquid heater includes an inlet manifold providing liquid from the inlet to the heating element and the thermostatic mixing valve. The heating element may include an electrical resistance heating element. The controller may energize the heating element when the flow rate of the liquid exceeds a predefined value selected from within the range of about 0.3 gallons per minute to 2.0 gallons per minute. The controller may regulate a switching unit connecting the heating element to a line voltage. In certain embodiments, the flow sensor comprises a magnetic portion configured to slidably respond to the liquid flow rate in the liquid heater.

The foregoing and other aspects, embodiments, and features of the invention can be more fully understood from the following description in conjunction with the accompanying drawings. In the drawings like reference characters generally refer to like features and structural elements throughout the various figures. The drawings are not necessarily to scale, emphasis instead being placed upon illustrating the principles of the invention.

### BRIEF DESCRIPTION OF THE DRAWINGS

FIG. 1 is an assembly drawing illustrating various embodiments of an electric tankless liquid heater system;

FIGS. 2 and 3 are detailed views of one embodiment of an inlet manifold;

FIGS. 4A-4D are various views of one embodiment of a liquid heater for an electric tankless liquid heater system; where FIG. 4A is a sectional view, FIG. 4B a side view, FIG. 4C a switching unit side, side view, and FIG. 4D a proximate end, end view of the liquid heater;

FIGS. 5A and 5B are schematic electrical diagrams of various embodiments of main electrical connection terminal for one or more switching units for an electric tankless liquid heater system;

FIG. 6 is a schematic electrical circuit diagram of various embodiments of a controller for an electric tankless liquid heater system; and

FIGS. 7A and 7B are various views of one embodiment of a liquid heating system incorporating a mixing valve.

### DETAILED DESCRIPTION

This disclosure provides, in various aspects, systems for heating a liquid, for example, water. The systems may be configured to deliver, in various embodiments, hot liquids, and in particular hot water of a particular temperature and/or temperature range, at a certain flow rate and/or under various demand characteristics. Accordingly, in various embodiments, the disclosure describes systems for provision of hot water to one or more water fixtures, and in particular, for example, to a one or more fixtures with frequent and rapid changes in hot water demand. Examples of such fixtures and situations include, but are not limited to, multi-station wash basins in high traffic facilities (e.g., industrial washrooms at the end-of-shifts, washrooms in sports stadiums, etc.) and showers facilities (e.g., locker room facilities, dorm facilities, mass decontamination situations, etc.).

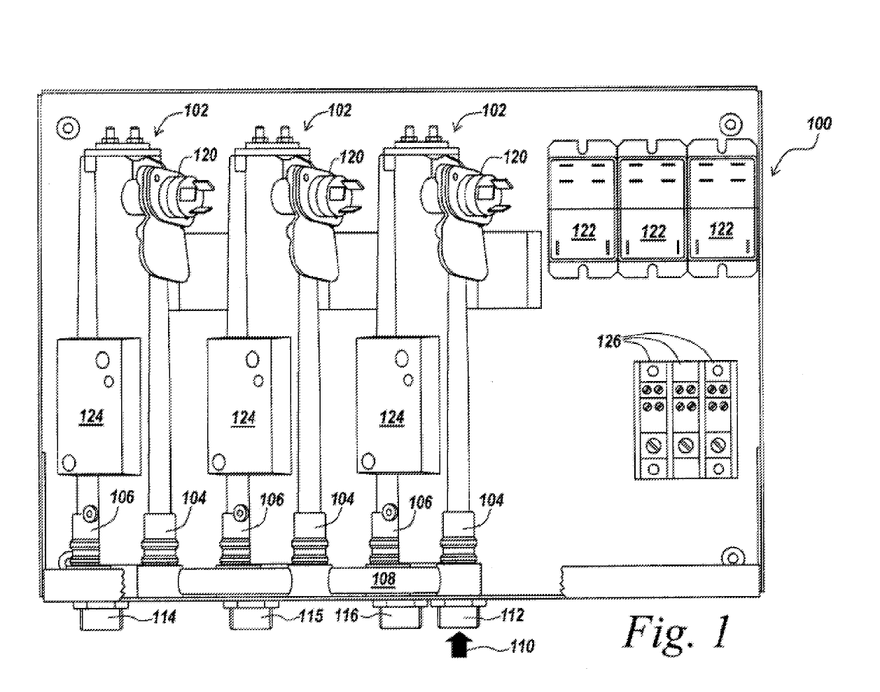

Referring to FIG. 1, in various embodiments, a tankless water heater system 100 comprises one or more liquid heaters 102 each having a liquid inlet 104 and a liquid outlet 106. Where the system includes multiple liquid heaters 102, the liquid inlets 104 of the liquid heaters 102 may be connected in a parallel flow relationship by an inlet manifold 108, which in turn can be connected to a source of liquid 110 to be heated, such as, e.g., a cold water line, by an inlet manifold connection fitting 112. The liquid outlets 106 of the liquid heaters 102 may each be connected to a separate outlet conduit 114, 115, 116. Each outlet conduit can be, for example, connected to a separate fixture for the supply of hot liquid. In other embodiments, the liquid outlets 106 of the liquid heaters 102 may be connected to an outlet manifold. For example and in one embodiment, the liquid outlets 106 may be connected in a parallel flow relationship by an outlet manifold, which in turn may be connected to a hot liquid supply line by an outlet manifold connection fitting. In yet other embodiments, a tankless water heater system 100 may comprise a single liquid heater 102 connected to a source of liquid 110 to be heated.

In various embodiments, each liquid heater 102 may include one or more electrical resistance heating elements. Electrical power to the electrical resistance heating elements may pass through a switching unit 120 and, in some embodiments, a separate circuit relay (also referred to as a contactor) 122 for each liquid heater. A controller 124, in various embodiments, mounted on the liquid heater, regulates the operation of a switching unit 120 and hence the current flow to one or more electrical resistance heaters of a liquid heater. The circuit relays 122, and therethrough one or more switching units, may be connected to a source of electrical power through taps in terminal blocks 126, which are connected to a source of electrical power (e.g., line voltage). In certain embodiments, use is also made of a ground terminal block. In some embodiments, a separate circuit relay 122 is used to energize or “arm” each switching unit and each switching unit regulates electrical current flow to the one or more electrical resistance heating elements connected thereto.

The controller may furnish an output control signal to a switching unit (such as, e.g., a bi-directional triode thyristor or “triac”), which gates power from a terminal block for selectively energizing one or more electrical resistance heating elements of a liquid heater. Solid state switching units, such as triacs, used alone can have some leakage current as they deteriorate, or if their blocking voltage rating has been exceeded. Some embodiments of the controller utilize a circuit relay installed in series with one or more switching units. In certain embodiments, the controller regulates electrical current flow to one or more electrical resistance heating elements in response to a signal produced by a temperature sensor, a flow sensor, or both. The controller may be configured to prevent energizing an electrical resistance heating element of the liquid heater until the flow rate of the liquid through the liquid inlet channel reaches or exceeds a predefined flow rate threshold. In various embodiments, the controller is configured to prevent energizing an electrical resistance heating element of the liquid heater until the flow rate reaches or exceeds a predefined value, for example, 0.3 gallons per minute (gpm), 0.5 gpm, 1 gpm or 2 gpm, responsive to a flow sensor, although other values may be configured for the liquid heater or flow sensor. Various flow sensors may support different flow rate thresholds. In some embodiments, a flow sensor may be configurable to support a desired flow rate threshold, for example, 2 gpm, 5 gpm or 10 gpm.

The liquid heater may include a temperature sensor, operably disposed in a liquid outlet channel of the liquid heater, which provides a signal to the controller for regulating electrical current flow to one or more electrical resistance heating elements and maintaining a desired output liquid temperature for the tankless liquid heater system. The tankless liquid heater and/or heating element may be designed, configured and/or constructed for heating liquid to a temperature of between about 90 degrees Fahrenheit and 200 degrees Fahrenheit. In various embodiments and application, temperature ranges may be narrower or different, e.g., 85 degrees Fahrenheit to 105 degrees Fahrenheit.

A tankless liquid heater system can be mounted in a housing comprising an enclosure containing mounting points for electrical components (for example, circuit relays, and terminal blocks) in addition to the liquid heaters. In various embodiments, the liquid heaters are mounted to the casing using brackets (e.g., angle brackets) which are directly mounted to the enclosure. In one embodiment, corresponding to a heating system comprising three liquid heaters, the casing has dimensions of about 15 inches wide, by about 12 inches high, by about 4 inches deep.

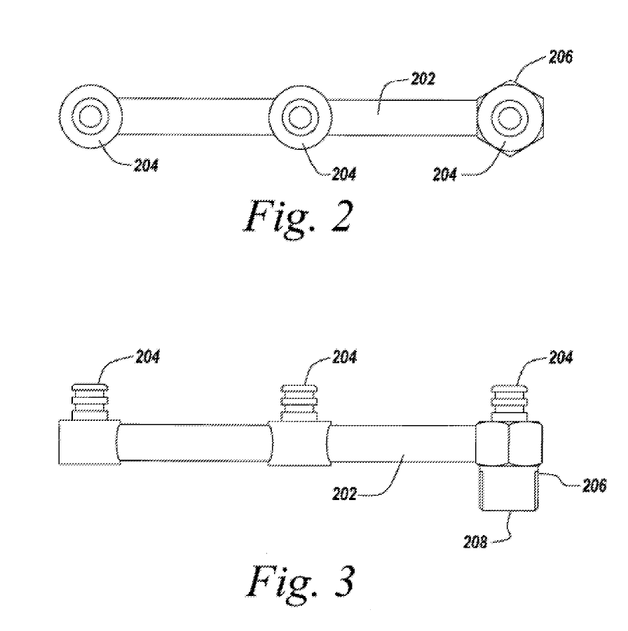

FIGS. 2 and 3 provide top (FIG. 2) and side views (FIG. 3), respectively, of one embodiment of an inlet manifold suitable for use in a tankless electric liquid heater system comprising a plurality of liquid heaters 102. In general, the inlet manifold comprises a manifold line 202 connecting, in a liquid flow relationship, heater connection fittings 204 for connecting the inlet manifold to the liquid inlets of a liquid heater. The inlet manifold further comprises a manifold connection fitting 206 (e.g., a boss having an integrally threaded portion) having an interconnection portion 208 for coupling the inlet manifold to a source of liquid.

In some embodiments, an inlet manifold comprises a manifold line of copper tubing (e.g., one-half inch tubing) and each heater connection fitting comprises a brass boss having one-half inch bores and two circumferential indents each for seating an O-ring (e.g., one-half inch O-ring) to provide a seal against the inlet channel of a liquid heater when the liquid heater is seated thereon. The O-rings may be of buna-n-nitrile or other material, and in some embodiments, the heater connection fittings are soldered to the manifold line. The manifold connection fitting may comprise a brass boss (e.g., having a five-eighths inch bore) and an interconnection portion suitable for accepting a compression fitting. In various embodiments including a coupling line, the coupling line may comprise copper tubing (e.g., three-quarter inch tubing) and the coupling portion may utilize an O-ring (e.g. one-inch buna-n-nitrile O-ring) to circumferentially seal against the coupling line.

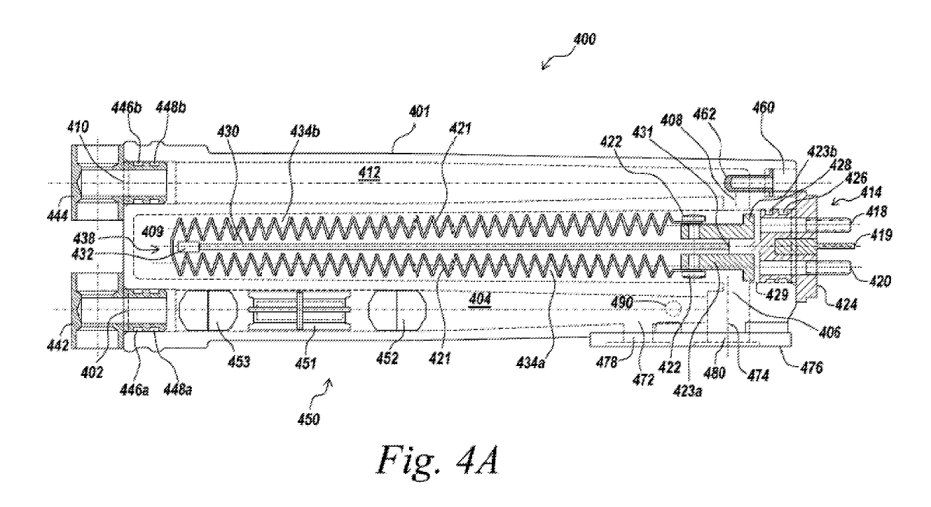

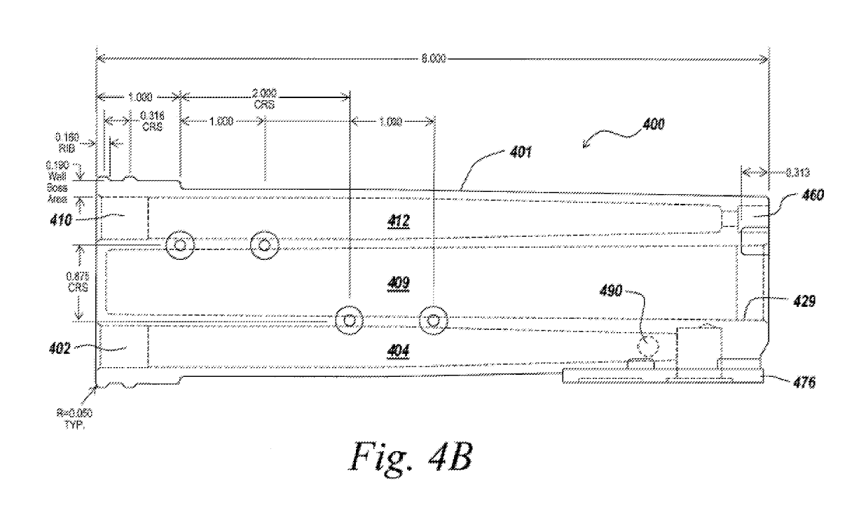

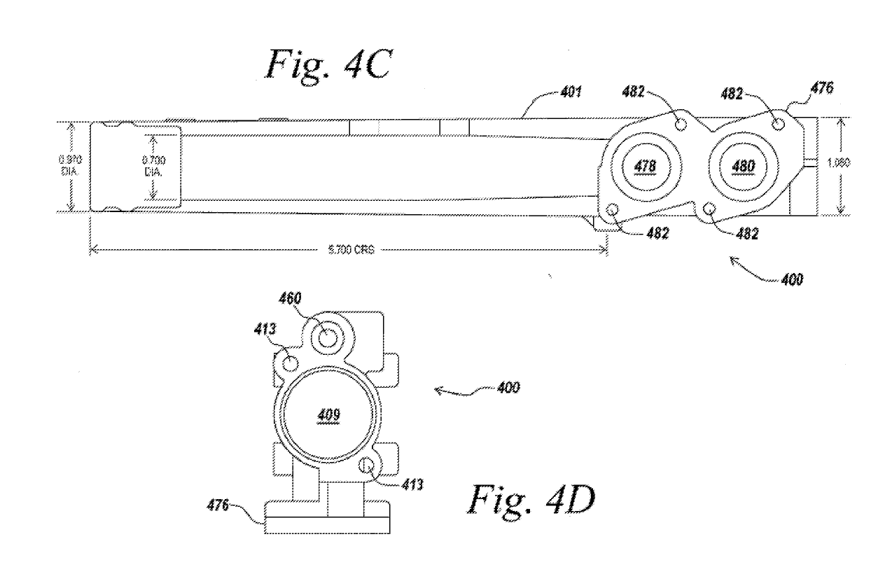

Referring to FIGS. 4A-4D, in various embodiments, a liquid heater 400 comprises a housing 401 having a liquid inlet 402, a liquid inlet channel 404 integrally including the liquid inlet 402, cross channels 406, 408 communicating with a central channel 409, a liquid outlet 410, and a liquid outlet channel 412 integrally including the liquid outlet 410. In one embodiment, the various dimensions illustrated in FIGS. 4B and 4C are in inches. The liquid heater may further comprise a heater cartridge 414, which can be fully separable from the housing 401 and capable of being removed and replaced without disconnecting the housing 401 from the inlet manifold and outlet conduits. In some embodiments, compatible heating cartridges with substantially the same or different design, configuration, materials and/or components, such as an upgraded product, may be replaced into the housing 401. The heating cartridge 414 may be releasably secured to the liquid heater housing 401 by removable fasteners inserted in securement openings 413 (e.g., passages for bolts, rivets, pins and stud, and threaded holes for screws), and it can be seen in FIGS. 1 and 4A-4D that the heater cartridge 414 can be readily released from the liquid heater without disturbing the existing mounting of the liquid heater and its plumbing connections to the inlet manifold and outlet conduits or manifold.

The heater cartridge 414 may comprise termination rods 418, 420 for electrically connecting an electrical resistance heating element 421 to a switching unit. The heater cartridge 414 further include an electrically-insulative element divider 419. The electrical resistance heating element 421 may be connected by fasteners 422 (e.g., screws, studs, pins, rivets or bolts) to members 423a, 423b, which are connected to, or formed together with their respective termination rods. In some embodiments, each fastener provides a flat surface portion for better securement against the respective member and better electrical contact between the electrical resistance heating element 421 and the member than a curved surface. An end portion of the heating element 421 may form at least a partial loop or hook around a respective fastener 422. In some embodiments, the members 423a, 423b are a portion of, or integrated with, the respective termination rods. The termination rods 418, 420 may be supported by a heater cartridge head 424 having head portion indents 426, 428 for seating O-rings, which become radially compressed and seal the cartridge head 424 against the walls of the central channel at the proximate end 429 of the housing 401 when the heater cartridge 414 is inserted into the central channel 409. In some embodiments, the heater cartridge head 424 may additionally or alternatively comprise screw threads or other fastening and/or sealing means for fitting against the walls of the central channel at the proximate end 429 of the housing 401 when the heater cartridge 414 is inserted into the central channel 409.

The heater cartridge 414 may further comprise a separator 430 having a proximate end 431 connected to the cartridge head 424. In some embodiments, the separator 430 is connected to an electrically conductive member 432 at the distal end. The separator 430 may comprise an electrically-insulating structure or web. The separator 430 may be part of, or integrated with the heater cartridge head 424. In some embodiments, the separator 430 and/or the electrically conductive member 432 define in the central channel 409 successive first and second interior channels 434a, 434b in fluid communication, respectively, with the liquid inlet channel 404 and the liquid outlet channel 412. In other embodiments, the separator 430 and/or the electrically conductive member 432 define in the central channel 409 an interior channel for communicating fluid between the liquid inlet channel 404 and the liquid outlet channel 412. In yet other embodiments, the heater cartridge 414 may comprise a separator 430 with one or more electrically conductive members 432 defining in the central channel 409 more than two successive interior channels in fluid communication between the liquid inlet channel 404 and the liquid outlet channel 412.

In various embodiments and in accordance with the shape and/or number of channels defined between the liquid inlet channel 404 and the liquid outlet channel 412, the electrical resistance heating element 421 may be arranged in various configurations, such as in a generally V-shaped or W-shaped configuration. In certain embodiments, the electrical resistance heating element 421 is arranged in a generally U-shaped configuration, bridging about the distal end of the separator 430. Such bridging, by a portion of the electrical resistance-heating element may place this portion 438 under mechanical stress and define a mechanically stressed portion 438 of the electrical resistance heating element 421. One or more electrically conductive members 432 may be disposed on the separator 430 (e.g., on the distal end). Each electrically conductive member 432 may be in electrical contact with at least a portion of the electrical resistance heating element preceding and with a portion following the mechanically stressed portion 438 to shunt current flow across the electrically conductive member 432. The shunting of current flow may substantially eliminate the electrical current flow through the mechanically stressed portion 438. The shunting of current flow may substantially eliminate or reduce damage or failure at or near the mechanically stressed portion 438.

Each of the electrical resistance heating elements may comprise at least one continuous, sheathless, coils. In some embodiments, the electrical resistance heating elements may comprise at least one continuous, sheathed or partially sheathed, coils. In some embodiments, suitable electrical resistance heating element materials include, but are not limited to, nickel-chromium alloys, and iron-chromium-aluminum alloys. Examples of suitable commercially available wire for utilization in electrical resistance heating elements can include NIKROTHAL 80 PLUS (an 80/20 NiCr alloy wire manufactured by Kanthal International, Hallstahammar, Sweden and available from Kanthal, Bethel, Conn., USA), NICR-A (an 80/20 NiCr alloy wire manufactured by National Element Inc., North Carolina, USA), KANTHAL-D (a FeCrAl alloy wire manufactured by Kanthal), and FECRAL815 (a FeCrAl alloy wire manufactured by National). In certain applications, suitable wire B&S gauges may range from about 20 (about 0.0320 inch diameter wire) to about 25 (about 0.0179 inch diameter wire) depending on the wire material, operating voltage, current and power. In some other applications, suitable wire diameters may include 0.016 and 0.028 inch. However, various embodiments of the liquid heater system may use coils having a wire diameter between a range of about 0.003 inch to 0.125 inch for various applications.

In specific applications, the desired power dissipation of an electrical resistance heating element can vary from about 2.4 to 4.2 kilowatts (kW), for, for example, input flow rates between about 0.3 gpm to about 1 gpm. In various other implementations, power dissipation of an electrical resistance heating element may vary from about 1.8 to 12 kilowatts (kW), but not limited to this range. In various applications, the material and/or wire diameter of an electrical resistance heating element may be selected to maintain a safe and/or sustainable “watt-density” (e.g., watts per inch squared) during operation and facilitates maintaining a constant range of power per surface area during operation. A portion of the electrical resistance heating element may be damaged, worn, warped, overheat, conductively-weakened, or otherwise stressed temporarily or permanently if the “watt-density” and/or local temperature exceed safe and/or sustainable values. A mechanically-stressed portion of the electrical resistance heating element may be susceptible to damage, for example, as a result of electromigration and/or repeated expansion and contraction from heating cycles. A mechanically-stressed portion of the electrical resistance heating element may also be susceptible to being worn, warped, overheated, conductively-weakened, or otherwise stressed, temporarily or permanently. In some embodiments, a mechanically-stressed portion is more susceptible than another portion of the electrical resistance heating element to one or more of these effects.

Various examples of water temperature rises provided by various embodiments of the tankless liquid heater substantially similar to those illustrated in FIGS. 1-3 using liquid heaters substantially similar to that of FIGS. 4A-4D, for various values of electrical resistance heating element and operational parameters, are listed in Tables 1 below.

TABLE 1

| Voltage | Total | Total | kW | Temperature Rise ° F. |
|---|---|---|---|---|
| (volts) | Amps | kW | each heater | at 0.5 gpm (each heater) |
| 208 | 46 | 9.6 | 3.2 | 44 |
| 240 | 46 | 11.0 | 3.67 | 50 |
| 277 | 46 | 12.6 | 4.2 | 57 |

Table 2 below lists examples of water temperature rises provided by various embodiments of the tankless liquid heater similar to those illustrated in FIGS. 1-3 which have only two liquid heaters (“a two-outlet conduit design”) substantially similar to that of FIGS. 4A-4D, for various values of electrical resistance heating element and operational parameters.

TABLE 2

| Voltage | Total | Total | kW | Temperature Rise ° F. |
|---|---|---|---|---|
| (volts) | Amps | kW | each heater | at 0.5 gpm (each heater) |
| 208 | 31 | 6.4 | 3.2 | 44 |
| 240 | 31 | 7.3 | 3.67 | 50 |
| 277 | 31 | 8.4 | 4.2 | 57 |

Referring again to FIGS. 4A-4D, and in some embodiments, the liquid inlet 402 of a liquid heater is connected to an inlet manifold by inlet heater connection fitting 442, and the liquid outlet 410 of a liquid heater is connected to an outlet conduit by an outlet heater connection fitting 444. The heater connection fittings may have indents 446a, 446b, 448a, 448b for seating O-rings, which upon insertion of the heater connection fittings into the liquid inlet 402 and liquid outlet 410, become radially compressed and seal, respectively, the inlet heater connection fitting 442 in the liquid inlet channel 404 and the outlet heater connection fitting 444 in the liquid outlet channel 412.

In certain embodiments, the liquid heater 400 includes a flow sensor 450 operably disposed in the liquid inlet channel 404 and responsive to the flow rate of liquid through the liquid inlet channel 404 and/or the flow sensor 450. In various other embodiments, the flow sensor 450 may be operably disposed at any location along the flow of liquid through the liquid heater 400, for example in the liquid inlet 402, inlet manifold, inlet heater connection fitting 442, liquid outlet 410, outlet conduit or outlet heater connection fitting 444. The flow sensor 450 may comprise a rotometer. In some embodiments, the flow sensor 450 includes a magnetic portion 451 slidably disposed in the liquid inlet channel 404 (or at any location in the flow path of liquid through the liquid heater), and may be bounded by travel stops 452, 453. In operation, liquid flow through the liquid inlet channel 404 of a sufficient flow rate may force the magnetic portion 451 towards the downstream travel stop 452. In certain embodiments, the controller is responsive to the position of the magnetic portion 451 within the liquid inlet channel 404. For example, in various embodiments, at sufficient liquid flow rates through the liquid inlet channel 404 the position of the magnetic portion 451 aligns with one or more magnetically activatable switches (e.g., reed switches) of the controller such that the magnetically activatable switches permit the energization of the electrical resistance heating element 421 to various heat generation levels.

The liquid heater may include a temperature sensor, such as, for example, a thermistor. In various embodiments, the housing 401 has a temperature sensor receipt opening 460 in the proximate end of the housing for insertion of a temperature sensor 462 therein, to dispose at least a portion of the temperature sensor 462 in the liquid outlet channel 412.

In various embodiments, one or more switching units (such as, for example, triacs) may be supported on the liquid heater housing 401 and in fluid communication with the liquid inlet channel 404 to assist in preventing overheating of the switching unit. In one embodiment, the housing 401 may have side openings 472, 474 formed in a sidewall thereof and a mounting plate 476 for mounting the switching units, the mounting plate 476 having plate openings 478, 480 and bolt securement passages 482 adjacent same for securing switching units thereto.

The liquid heater may further include a pressure relief valve incorporated in the housing. Referring to FIGS. 4A-4D, and in various embodiments, the pressure relief valve comprises a valve mechanism seated in a passage 490 in the housing 401, which is in fluid communication with the liquid inlet channel 404. In some embodiments, the pressure relief valve is a resettable valve mechanism having a spring-loaded brass piston and seat. In various embodiments where the housing is rated for a maximum operating pressure of, for example, 150 psi, the pressure relief valve may, for example, be set to start actuation at 170 psi.

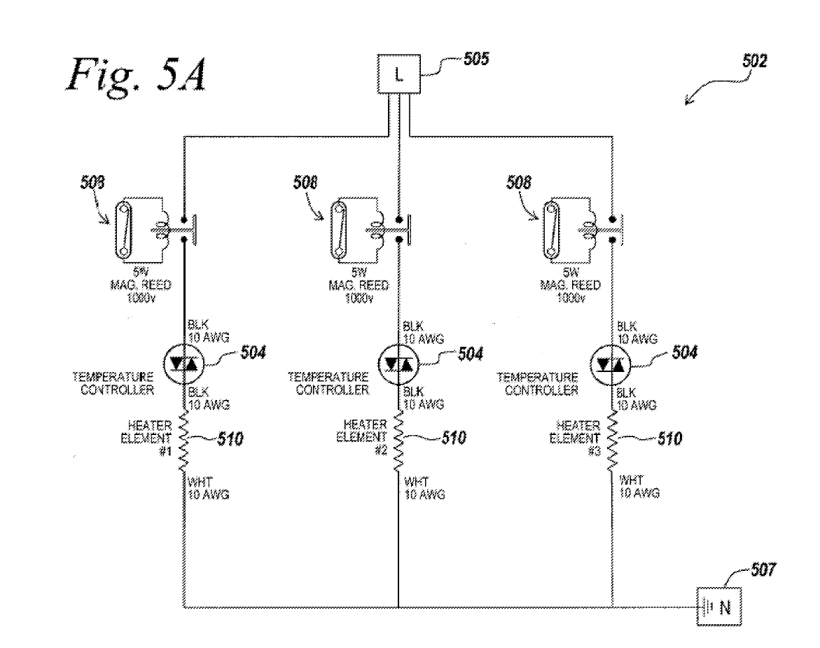

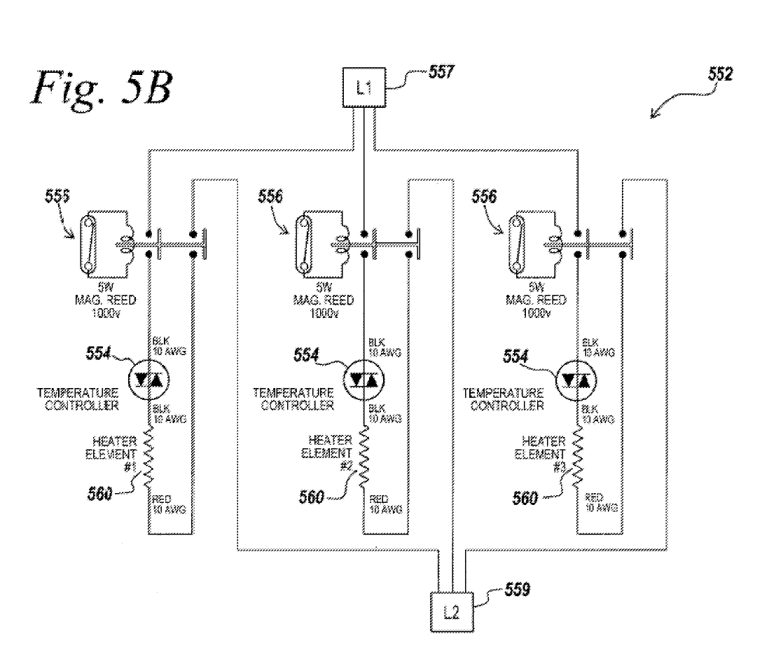

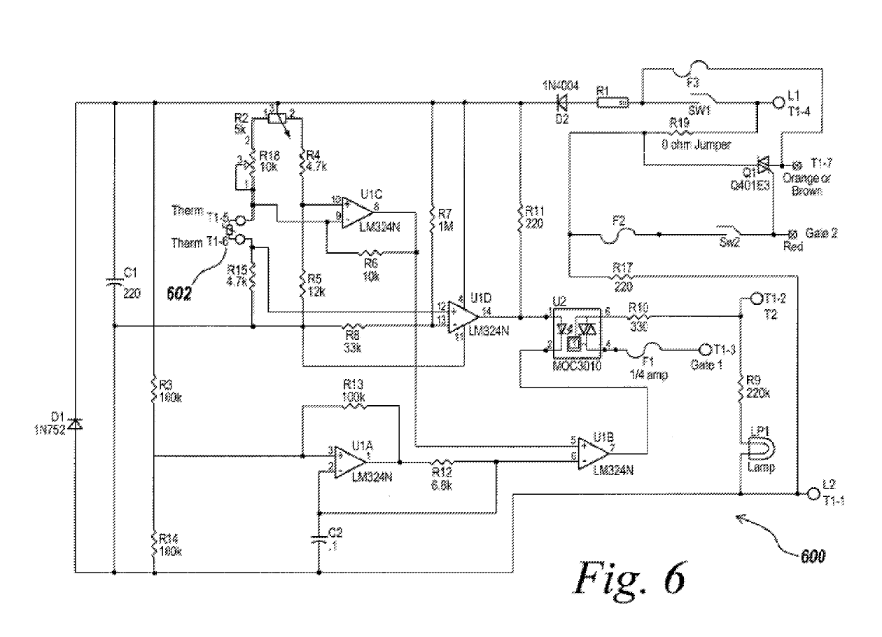

FIGS. 5A and 5B schematically illustrate various embodiments of main electrical connection for switching units in series with a circuit relay for a liquid heater system. FIG. 5A illustrates a configuration 502 for connecting a switching unit 504 (here a triac) to line voltage L, 505 and a ground N, 507. The configuration illustrated is for a typical 277 volt (V) application, although other power ratings can be supported. Each switching unit 504 may be electrically connected to line voltage L through a separate circuit relay 508 (such as, e.g., a 3 watt (W), 1000 V magnetic reed switch). The switching unit 508 may in turn be electrically connected to a respective electrical resistance heating element 510 of a liquid heater (here, one element per liquid heater) and the circuit completed by electrical connection to a ground N, 507.

FIG. 5B illustrates a configuration 552 for connecting a switching unit 554 (here a triac) in series with a circuit relay 556 to two 120 V line voltages L1, 557 and L2, 559. The configuration illustrated is for a typical 208-240 V application, although other power ratings can be supported. The switching unit 554 may be electrically connected to the first line voltage L1, 557 through a circuit relay 556 (such as, e.g., a 3 W, 1000 V magnetic reed switch). The switching unit 554 may in turn be electrically connected to a respective electrical resistance heating element 560 of a liquid heater (here, one element per liquid heater). The circuit may be completed for each electrical resistance-heating element 560 by electrical connection to the second line voltage L2, 559 through a circuit relay 556.

In certain embodiments, the tankless liquid heater includes a controller which provides thermostatic control, for example, by monitoring one or more of liquid outlet temperature, inlet flow rate, and outlet flow rate. The controller may provide thermostatic control via signals received from the temperature sensor. The controller may adjust the energization of liquid heaters and the current flow to the electrical resistance heating elements to facilitate maintaining liquid outlet temperature below a maximum temperature value. In various embodiments, the maximum temperature value may be in the range between about 102° F. to about 106° F., and the maximum temperature value may be set at about 105° F., for example.

In some embodiments, The controller may adjust the energization of one or more liquid heaters and the current flow to the respective electrical resistance heating elements to facilitate maintaining liquid outlet temperature within a selected temperature range. In various embodiments, the selected temperature range may be between about 90° F. to about 105° F., and in another example, the selected temperature range may be between about 100° F. to about 105° F. The controller may regulate a circuit relay installed in series with the switching unit to, for example, increase dielectric strength and with the ability to disarm the switching unit when the flow rate, as sensed by a flow sensor, is below a predetermined threshold value.

Referring to FIG. 6, various embodiments of a controller are illustrated. Further details of the electrical components of FIG. 6 are provided in Tables 3 and 4 for two exemplary versions. In the schematic of FIG. 6, the control circuit 600 may, in some embodiments, provide a control signal to one or more switching units on Gate 1 T1-3 and a control signal to one or more circuit relays on T1-7. It can be seen that the control signal for the one or more switching units may be regulated by a trigger device U2 (here an optical coupler) which is triggered (here the light emitting diode is driven when triggered) in response to a signal from a temperature sensor 602 (here a thermistor). The trigger device may be configured to turn the switching unit on at the zero-crossing to minimize radio frequency interference.

In operation, the temperature sensor 602 may sense the liquid temperature thereby producing a signal, which may be conditioned and amplified, and may be provided to the trigger device U2 (e.g., across pins 1 and 2 for the specific application illustrated using a MOC3010, ZCross Optocoupler from Motorola, Inc.). If the liquid temperature is adequately high for the selected temperature point (as controllably established by resistor R18), the control signal on output Gate 2 T1-3 may not cause the associated switching unit to energize the one or more electrical resistance heating elements connected thereto. In addition, if the liquid flow rate as sensed by the flow sensor is below a predetermined and/or preconfigured threshold level, the relay switches SW1 and SW2 may remain open, resulting in a control signal on T1-7 which can cause the circuit relay to remain open and may prevent current flow to the associated electrical resistance heating elements.

When the liquid temperature as sensed by the temperature sensor 602 falls below a temperature set point, the trigger device U2 may be triggered (here, e.g., the light emitting diode emits), generating a control signal on output Gate 2 T1-3 permitting the associated switching unit to energize. However, for current flow to reach the one or more electrical resistance heating elements associated with the switching unit, the liquid flow rate, as sensed by the flow sensor, must, in some embodiments, be equal to or above a predetermined threshold level to close the relay switches SW1 and SW2. This may result in a control signal on T1-7 which causes the circuit relay to close and may permit current flow to the switching unit and associated one or more electrical resistance heating elements. For example, in various embodiments where the flow sensor comprises a magnetic portion configured to slidably respond to the liquid flow rate through a liquid heater, liquid flow through the liquid heater of equal to or above a predetermined flow rate threshold may force the magnetic portion to slide into an alignment with the relay switches SW1 and SW2. The alignment may close the switches, and may permit the energization of the associated electrical resistance heating element. In some embodiments, the flow sensor thus provides a signal to the controller via the magnetic force exerted by the magnetic portion on the relay switches SW1 and SW2.

TABLE 3

| Element | Device | Value, Version 1 | Value, Version 2 |
|---|---|---|---|
| C1 | Capacitor | 220 ufd/10 v | 220 ufd/10 v |
| C2 | Capacitor | 0.1/50 v | 0.1/50 v |
| D1 | Zener Diode | 1N752 | 1N752 |
| D2 | Diode | 1N4004 | 1N4004 |
| F1 | MCR-Fuse | 0.25 A | 0.25 A |
| F2 | MCR-Fuse | 0.25 A | not present |
| F3 | MCR-Fuse | not present | 0.25 A |
| LP1 | Neon Lamp | 2 ml LAMP | 2 ml LAMP |
| Q1 | 1A Triac | Q4 01E3 | Q4 01E3 |
| R1 | Power Resistor | see Table 4 below | see Table 4 below |
| R2 | Potentiometer | 5k | 5k |
| R3 | Resistor 1/4W 5% | 100k | 100k |
| R4 | Resistor 1/4W 5% | 4.7k | 4.7k |
| R5 | Resistor 1/4W 5% | 12k | 12k |
| R6 | Resistor 1/4W 5% | 10k | 10k |
| R7 | Resistor 1/4W 5% | 1M | 1M |
| R8 | Resistor 1/4W 5% | 33k | 33k |
| R9 | Resistor 1/4W 5% | 220k | 220k |
| R10 | Resistor 1/4W 5% | 330 | 330 |
| R11 | Resistor 1/4W 5% | 220 | 220 |
| R12 | Resistor 1/4W 5% | 6.8k | 6.8k |
| R13 | Resistor 1/4W 5% | 100k | 100k |
| R14 | Resistor 1/4W 5% | 100k | 100k |
| R15 | Resistor 1/4W 5% | 4.7k | 4.7k |
| R17 | Resistor 1/4W 5% | 220 - | not present |
| R18 | Potentiometer | 10k | 10k |
| R19 | Resistor 1/4W 5% | 0 ohm | 0 ohm |
| SW1 | Reedswitch | HYR2016 | HYE2016 |
| SW2 | Reedswitch | HYR2016 | not present |
| T1 | EDS500V-06-P-M | T-Block | T-Block |
| U1 | LM324N | LM324N | LM324N |
| U2 | ZCross Optocoupler | MOC3010 | MOC3010 |

TABLE 4

| Voltage | | R1 Values |
|---|---|---|
| 120 | V | 2.4k, 5 W |
| 208-240 | V | 5k, 5 W |
| 277 | V | 6.2k, 5 W |

A user and/or a manufacturer of a liquid heater may control, adjust, select or otherwise apply a temperature set point to the liquid heater. In certain embodiments, a user may apply one of a plurality of temperature set points to a liquid heater. A user may apply a temperature setting to the temperature sensor and/or controller of the liquid heater. For example and in one embodiment, when heated liquid from a liquid heater reaches a temperature specified by the temperature setting, a temperature sensor of the liquid heater may generate a signal to a respective controller to de-energize a heating element of the liquid heater. The temperature setting of the liquid heater is, in certain embodiments, calibrated to provide heated liquid of a particular temperature, maximum temperature, minimum temperature and/or temperature range. A range of temperature settings may be available for a liquid heater, for example, through a liquid temperature dial, slider control, or electronic programming interface.

In one embodiment, and by way of illustration, a user may set a water heater to a temperature set point of 100 degrees F. and expect to receive heated water of approximately 100 degrees F. However, conventional liquid heating systems do not always have good control over the temperature of heated water they provide. For example, a rapid change in liquid flow rate through a liquid heater may cause a significant temperature change in the heated water deviating from a temperature set point. A rapid or sudden change that elevates the temperature of heated water may be dangerous, for example, scalding a user or causing a sudden shock to a user (e.g., in a shower) leading to a fall and/or injuries.

Elevated temperature, including temperature spikes, may occur as a result of latent heat in a highly energized heating element in contact with a reduced liquid flow over a short period of time. Since there is reduced liquid flow to carry away the heat from the heating element, the lower volume of water may be overheated during the short period of time. In certain cases, a liquid heater's controller and/or sensors may not be able to react within the short timeframe of the change in liquid flow rate. The heater's heating element may still be generating heat, for example, because the flow sensor has not signaled to the controller to de-energize the heating element, or because the liquid flow is still above a threshold for de-energizing the heating element. Equipment failure in a liquid heater, such as in the temperature sensor, controller and/or heating element, may also result in an unexpected change in liquid temperature. Various embodiments of tankless liquid heaters disclosed in this application may incorporate one or more thermostatic mixing valves to improve temperature control for liquid exiting the liquid heater. A mixing valve may be located downstream of heated liquid flow from a heating element and receives at least a portion of the heated liquid flow.

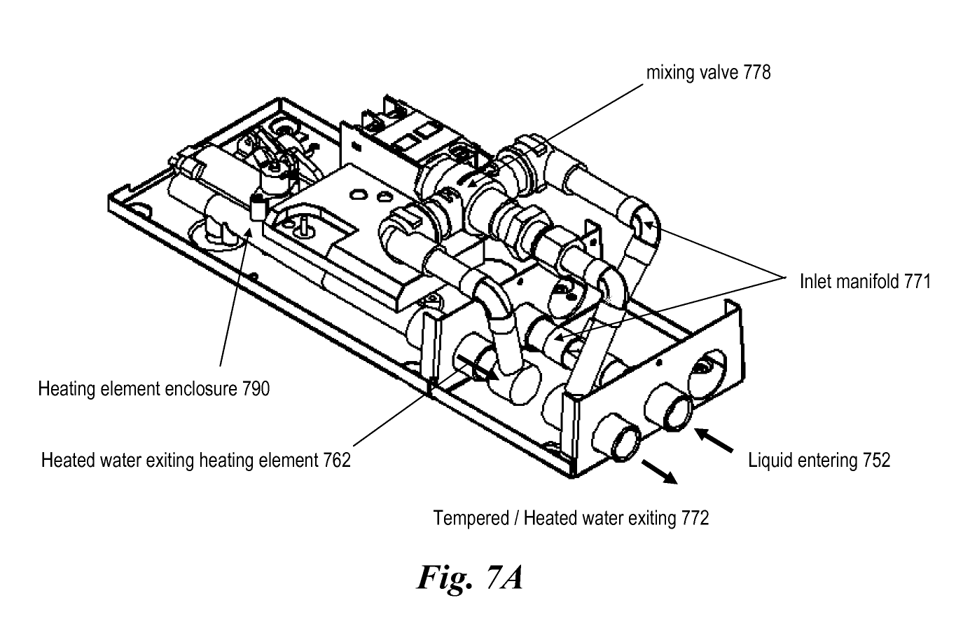

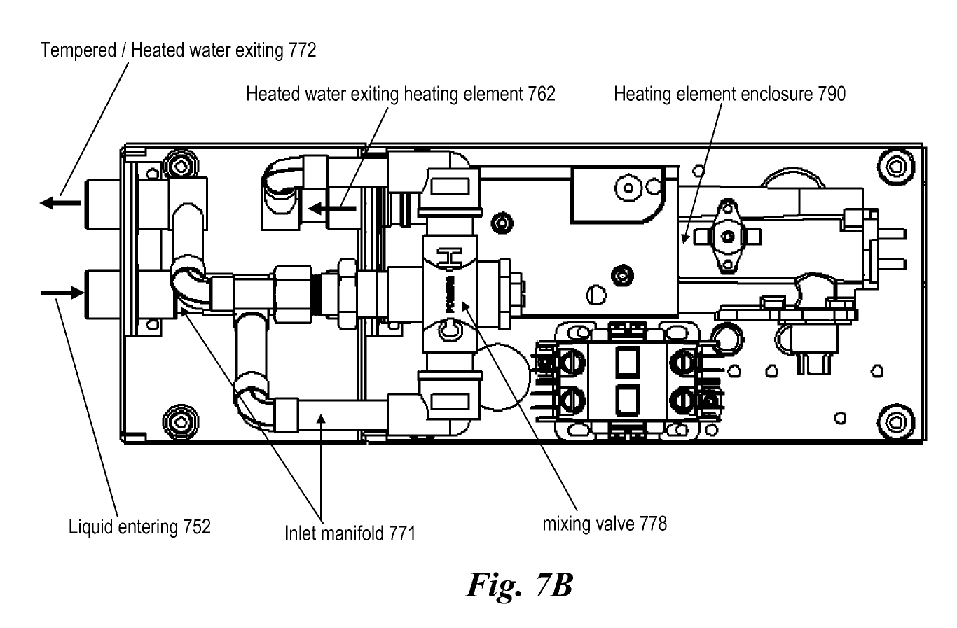

Referring now to FIG. 7A, one embodiment of a tankless liquid heating system using a thermostatic mixing valve is depicted. In brief overview, the tankless liquid heating system may include an input manifold 771, one or more heating elements, a controller, a flow sensor, a temperature sensor and a mixing valve 778. The tankless liquid heater receives liquid 752 at an inlet and provides heated liquid 772 at an outlet. The liquid 752 at the inlet may be of any temperature and may, for example, be obtained via plumbing connecting a water mains outlet or other liquid source. In certain embodiments, a plurality of liquid inlets may direct liquid from one or more sources into the tankless liquid heating system.

In some embodiments, the tankless liquid heating system includes an inlet manifold 778. The inlet manifold 778 may include one or more features of the inlet manifold described above in connection with FIGS. 1-3. The inlet manifold 778 may direct, channel or otherwise provide liquid 752 from the inlet of the tankless liquid heating system to the heating element and/or the thermostatic mixing valve 778. In certain embodiments, the inlet manifold 771 is designed and/or constructed to provide liquid 752 from the inlet of the tankless liquid heating system to the heating element when the mixing valve 778 does not divert liquid flow for mixing. The inlet manifold 771 may be designed and/or constructed to provide at least a portion of liquid 752 from the inlet of the tankless liquid heating system to the mixing valve 778 when the mixing valve enters a mixing mode. The inlet manifold 771 may be designed and/or constructed to provide a substantial portion of the liquid 752 from the inlet of the tankless liquid heating system to the mixing valve 778 when the mixing valve enters the mixing mode. For example, the inlet manifold 771 may include a liquid channel between the inlet and the mixing valve 778 that is substantially wider and/or shorter than a respective channel to the heating element.

In some embodiments, the inlet manifold 771 is a passive element that directs liquid flow to one or both of the mixing valve 778 and the heating element based on liquid demand from the mixing valve 778 and the heating element. Liquid demand may be embodied by a fluid pressure drop stemming from the mixing valve 778 and/or the heating element. For example and in one embodiment, an imbalance in fluid pressure between the liquid source and the mixing valve 778 and/or the heating element may cause liquid to flow towards equalizing the pressure imbalance. A fluid pressure differential between the liquid source and the mixing valve and/or the heating element may cause liquid to be apportioned accordingly between the heating element and the mixing valve 778. In certain embodiments, a substantial liquid pressure drop at the mixing valve 778 may cause the inlet manifold 771 to channel most or all of the inlet liquid 752 to the mixing valve 778. In some embodiments, the liquid source (e.g., water mains) provides liquid pressure that directs liquid flow to the mixing valve 778 and/or the heating element when a path opens for liquid flow to the mixing valve and/or the heating element. For example, if a user turns on a tap that receives water from the heating element, the water pressure differential between the tap and the water source may direct water flow to the tap.

In some embodiments, the inlet manifold 771 is an active element that diverts a portion of liquid 752 from the inlet to one or both of the mixing valve 778 and the heating element. The inlet manifold 771 may actively divert liquid flow based on liquid demand from the mixing valve and/or the heating element. For example and in one embodiment, the inlet manifold 771 may include one or more valves, directional vanes, pumps and/or rotors to divert or direct liquid to the mixing valve 778 and/or the heating element. A temperature sensor near or incorporated into the mixing valve 778 may send a signal to the inlet manifold 771 to mechanically or otherwise direct liquid flow into the mixing valve 778. A controller, e.g., incorporating a feedback control system, may control the amount of liquid flow from the inlet manifold 771 into the mixing valve 778 and/or the heating element. This controller may include one or more features of the controller described above in connection with FIGS. 5A-B and 6.

In some embodiments, the inlet manifold 771 receives liquid from a plurality of liquid sources. The inlet manifold 771 may selectively (e.g., through valves) receive liquid flow from the plurality of liquid sources, and may do so responsive to liquid demand. The inlet manifold 771 may channel liquid from a particular liquid source exclusively or substantially to one of the mixing valve 778 or the heating element. For example, the inlet manifold 771 may include two isolated channels, communicating liquid in one channel to the mixing valve 778 and liquid in another channel to the heating element. In some embodiments, the inlet manifold 771 may channel cold liquid (e.g., cold relative to liquid from the heating element) to the mixing valve. In one embodiment, the inlet manifold may channel preheated liquid to the heating element. In some embodiments, the inlet manifold may provide a dedicated channel for a liquid source feeding liquid to the mixing valve 778, e.g., so that liquid is not diverted from the heating element.

The inlet manifold 771 may provide a dedicated channel for a liquid source feeding the mixing valve 778, so that a substantial amount of liquid is available on-demand to mix with heated water, e.g., to prevent scalding. The inlet manifold 771 may provide a dedicated channel for a liquid source feeding the mixing valve 778 so that operation of the heating system, e.g., energization characteristics of the heating element, is not unduly affected by operation of the mixing valve 778. In certain embodiments, however, only one liquid source may be available. Moreover, it may be more cost-effective and/or easier to implement the heating system using a single liquid source.

In some embodiments, the inlet manifold 771 includes a flow controller to control the liquid flow through the inlet manifold 771 to the mixing valve 778 or the heating element. The flow controller may provide and maintain a minimum liquid flow available to each of the mixing valve or the heating element. The flow controller may limit liquid flow available to each of the mixing valve 778 or the heating element, e.g., to prevent an excessive drop in liquid flow through the heating element, or available to the mixing valve. The inlet manifold 771 may include a flow controller that incorporates feedback control in managing liquid flow to the mixing valve and/or the heating element. In some embodiments, the flow controller apportions liquid flow between the mixing valve 778 and the heating element. The flow controller may apportion the liquid flow so that operation of the heating system, e.g., energization characteristics of the heating element, is not unduly affected by the operation of the mixing valve. For example and in one embodiment, the flow controller may apportion the liquid flow so that the portion of liquid flow received by the heating element is above a pre-configured flow rate threshold such that the controller does not have to de-energize the heating element, e.g. over the course of a sudden decrease and recovery in the demand for liquid. In some embodiments, repeated or excessive electrical cycling of the heating element may degrade the life and/or performance of the heating element.

The inlet manifold may include a plurality of elements assembled together, e.g., using a plurality of straight and curved sections of pipes, connectors and fittings. In certain embodiments, the inlet manifold may include a single unit, e.g., cast using a mold, or machined into form. The inlet manifold may comprise any material, such as metal, alloy, plastic, composite and/or ceramic.

The tankless liquid heating system may include a heating element for heating liquid received from the inlet of the liquid heater. Some embodiments of a heating element are described above in connection with FIG. 4A. The heating element may include an electrical resistance heating element. Various embodiments of a heating element may incorporate bare nichrome (or other metallic) wire elements, sheathed elements, magnetic induction elements, plate or electroplated heating elements, and/or inductive coils. Some or all of these heating elements may be energized electrically or otherwise by a controller of the heating system. Heating systems that utilize fuel-heating methods may also include a controller to activate a respective heating element. As such, the methods and principles discussed herein can apply to various types of heating systems.

The liquid heating system may include a flow sensor indicating the flow rate of the liquid received by the heating element. Some embodiments of a flow sensor are described above in connection with FIGS. 4A and 4B. In certain embodiments, the flow sensor communicates a signal to the controller when the flow rate of liquid to the heating element exceeds or reaches a configurable and/or predefined threshold. Responsive to the signal, the controller may energize the heating element. The flow sensor may communicate a signal to the controller when the flow rate of liquid flowing to the heating element falls to or below a configurable and/or predefined value. Responsive to the signal, the controller may de-energize the heating element. In these embodiments, the flow sensor and/or controller may serve as a switch for turning on and off the heating element.

In certain embodiments, the flow sensor comprises a portion configured to slidably respond to the liquid flow rate in the liquid heater. The portion, which may be a magnetic portion, may slide or otherwise move along a channel or guide based on the pressure of the liquid flow. The portion may move based on the pressure of the incoming liquid against a gravitational, magnetic and/or mechanical force (e.g., elastic force). The portion may magnetically or mechanically switch on or off the heating element responsive to the liquid flow rate. For example and in one embodiment, the flow sensor includes a reed switch for turning on or off the heating element.

In some embodiments, a flow sensor measures the liquid flow rate to, through and/or leaving the heating element. The flow sensor may communicate the liquid flow rate to the controller, e.g., at preconfigured time intervals and/or in response to a detected or significant change in flow rate. Responsive to the communication, the controller may adjust or control the flow of electricity that energizes the heating element. Accordingly, the heating element's heat generation or dissipation level may be adjusted according to the liquid flow rate. In these embodiments, the flow sensor and/or the controller adjusts the energy level of the heating element and/or turns on and off the heating element, based on the flow rate of the liquid.

The liquid heating system may include one or more temperature sensors measuring the temperature of liquid entering and/or exiting the heating element. A temperature sensor may include one or more features of the temperature sensor described above in connection with FIGS. 4A-B, 5A-B and 6. In certain embodiments, a temperature sensor measures or responds to the temperature of liquid flowing to the heating element. The temperature sensor may communicate the temperature to the controller, to adjust or control the flow of electricity that energizes the heating element. The heating element's heat generation or dissipation level may be adjusted according to the temperature of the incoming liquid. In these embodiments, the temperature sensor and/or the controller adjusts the energy dissipation of the heating element, and/or turns on and off the heating element, based on the temperature of the incoming liquid.

A temperature sensor may measure or respond to the temperature of heated liquid exiting the heating element. The temperature sensor may communicate the temperature to the controller, to adjust or control the flow of electricity that energizes the heating element. The heating element's heat generation or dissipation level may be adjusted according to the temperature of the heated liquid. In these embodiments, the temperature sensor and/or the controller adjusts the energy level of the heating element, and/or turns on and off the heating element, based on the temperature of the heated liquid. The controller may regulate the amount of electrical current energizing the heating elements based on any combination of one or more of the temperature of the inflowing liquid, the temperature of the heated liquid, and the flow rate of the liquid, for instance, using a feedback control system.

The controller may regulate a switching unit connecting the heating element to a line voltage. As described above, the controller regulates the amount of electrical current energizing the heating element responsive to the flow sensor and/or the temperature sensor(s). The controller may energize the heating element when the flow rate of the liquid reaches or exceeds a predefined value. The controller may energize the heating element when the flow rate of the liquid reaches or exceeds a predefined value selected from within the range of about 0.3 gallons per minute to 2.0 gallons per minute, e.g., responsive to the flow sensor. The controller may prevent energizing the heating element when the heated liquid reaches or exceeds a predefined temperature or temperature set point T1, responsive to the temperature sensor.

The controller and/or the temperature sensor responding to the temperature of the heated liquid may be configured with a temperature set point T1, such that the controller can de-energize the heating element if the temperature of the heated liquid reaches or exceeds temperature T1. A user may substantially control the temperature of liquid exiting the heating system to be at, near or within a temperature range relative to the temperature set point T1. In some embodiments, the responsiveness of the controller and/or the temperature sensor to the temperature set point T1 may be controlled or subdued, such that small temperature spikes or fluctuations above T1 does not de-energize the heating element. The responsiveness of the controller and/or the temperature sensor to the temperature set point T1 may configured by a user, or may be an inbuilt characteristic or limitation of the controller and/or the temperature sensor. Such responsiveness may be an advantage in that temperature fluctuations above T1 over a very short period of time will not cause the heating element to cycle off and on in rapid succession. Temperature fluctuations above T1 over a very short period of time may be acceptable, for example, because these do not present a safety issue and/or may not be detectable by a user. Some or all of the temperature spikes or fluctuations may be suppressed or removed by operation of a mixing valve downstream from the heating element.

The liquid heating system may include a thermostatic mixing valve 778 for mixing the heated liquid with unheated or cold liquid. The thermostatic mixing valve 778 may mix the heated liquid with liquid 752 diverted from the heating system liquid inlet. Responsive to the temperature of the heated liquid, the thermostatic mixing valve 778 may mix the heated liquid with liquid having a lower temperature than the heated liquid. The mixing process may produce tempered liquid 772 of a lower or substantially lower temperature relative to the heated liquid 762. In some embodiments, the mixing valve 778 may not comprise a thermostatic mixing valve but its mixing operation is controlled by the controller, for example, responsive to a temperature sensor measuring the temperature of the heated liquid 762.

The mixing valve 778 may include an inlet for receiving cold or unheated liquid, such as liquid 752 diverted from the heating system's liquid inlet via the inlet manifold 771. The mixing valve 778 may include another inlet for receiving heated liquid 762 from the heating element. The mixing valve 778 may include a liquid outlet for delivering tempered (i.e., mixed) liquid or heated liquid (i.e., no mixing) 772. The mixing valve 778 may be configured to allow heated liquid at or below a particular temperature set point to pass through the valve without mixing. The mixing valve 778 may allow liquids from both inlets to mix when the heated liquid 762 is at or above a pre-configured temperature set point or value. In some embodiments, the mixing valve 778 allows liquids from both inlets to mix when the liquid exiting the outlet is at or above a pre-configured temperature set point. The mixing valve may include an adjustment screw, knob, dial or any other control structure or interface for configuring the temperature set point for the mixing valve 778.

In some embodiments, the mixing valve 778 mixes liquid diverted from the inlet 752 with the heated liquid 762 when the temperature of the heated liquid is at least a predetermined number of degrees Fahrenheit above a temperature set point T1 for the heating element and/or temperature sensor. In some embodiments, the controller de-energizes the heating element when the heated liquid 762 reaches or exceeds the temperature set point T1 for the heating element and/or temperature sensor. When the mixing valve set point is set at T1, the mixing valve 778 may mix the heated liquid when the temperature of the heated liquid reaches or exceeds T1. In some embodiments, the mixing valve 778 mixes liquid diverted from the inlet 752 with the heated liquid 762 when the temperature of the heated liquid is at least 5 degrees Fahrenheit above T1. In various embodiments, the temperature set point for the mixing valve may be set at any value relative to T1, such as 0, 1, 2, 3, 5, 8 or 10 degrees above T1.

In some embodiments, the mixing valve 778 diverts a significant amount of liquid 752 that may otherwise flow into the heating element. Responsive to the diverted liquid, the flow sensor may cause the heating element to be de-energized via the controller when the detected flow rate of liquid going to the heating element falls below a predetermined threshold. The flow sensor may cause the heating element to be de-energized even though the temperature sensor has not acted to cause the heating element to be de-energized. The heating element may be re-energized within a short period of time if the temperature fluctuation above T1 subsides within a short period of time. Short, rapid and/or frequent on-off cycles of the heating element may cause the performance and useful lifespan of the heating element to deteriorate. Therefore, in certain embodiments, operation of the mixing valve may be controlled by setting its temperature set point higher than that (T1) of the temperature sensor and/or controller. The frequency of operation or the sensitivity of the mixing valve to temperature fluctuations in the heated liquid may be reduced and/or adjusted by setting its temperature set point at various levels above that (T1) of the temperature sensor and/or controller. Accordingly, small temperature fluctuations above T1 may be allowed by the heating system without causing the mixing valve 778 to divert liquid away from the heating element.

In various embodiments, an abrupt and/or substantial drop in liquid demand may translate to an abrupt and/or substantial drop in the flow rate of liquid received by the heating element. The drop in the flow rate of liquid received by the heating element may result in a smaller volume of liquid for heating by the energized heating element. As a result, the smaller volume of liquid may be overheated by the heating element, sometimes beyond the temperature set point T1. The overheated liquid may exceed a temperature set point of the mixing valve and trigger a diversion of liquid from the heating system inlet. The diversion of liquid may further cause the flow rate of liquid received by the heating element to fall below a predefined flow rate value that will switch off the heating element. Thus, in certain embodiments, the thermostatic mixing valve mixes the heated (or overheated) liquid 762 with liquid diverted from the inlet when the flow rate of the liquid received by the heating element falls substantially over a short period of time. In some embodiments, the thermostatic mixing valve mixes the heated liquid 762 with liquid diverted from the inlet when the flow rate of the liquid received by the heating element falls substantially and instantaneously. In another embodiment, the thermostatic mixing valve mixes the heated (or overheated) water with liquid diverted from the inlet when the flow rate of the liquid received by the heating element falls below the predefined flow rate value over a short period of time. In yet another embodiment, the thermostatic mixing valve mixes the heated water 762 with liquid diverted from the inlet when the flow rate of the liquid received by the heating element falls below the predefined flow rate value instantaneously.

In some embodiments, the thermostatic mixing valve 778 outputs liquid with a preconfigurable temperature upper limit. The mixing valve 778 may mix liquid diverted from the inlet with the heated liquid when the temperature of the incoming heated liquid reaches or exceeds the preconfigurable upper limit or temperature set point. This temperature set point of the mixing valve may set be relative to, or independent of the temperature set point T1 of the temperature sensor and/or controller. For example, in the latter embodiment, the mixing valve may mix liquid diverted from the inlet with the heated liquid 762 when the temperature of the heated liquid reaches or exceeds about 110 degrees Fahrenheit. In various applications and embodiments, the temperature set point of the mixing valve 778 may set at various values, such as 105, 115, 120, 150, 180 degrees Fahrenheit.

The thermostatic mixing valve 778 may mix the liquid diverted from the inlet with the heated liquid 762 at a sufficiently fast rate to prevent a person in contact with the mixed water from being scalded. The thermostatic mixing valve 778 may divert a substantial amount of liquid from the inlet within a short amount of time for mixing with the heated liquid responsive to the temperature of the heated liquid. The thermostatic mixing valve 778 may support a liquid flow rate equal to or higher than that supported by the heating element. The thermostatic mixing valve 778 may be capable of mixing enough cold water into the stream of heated water to lower the output liquid to less than 120 degrees Fahrenheit. In some embodiments, the mixing valve conforms to American Society of Safety Engineers (ASSE) 1070 performance requirements. In certain implementations of the heating system, the mixing valve may be replaced by a temperature limiting or tempering device, such as a device conforming to ASSE 1070. Some implementations of the heating system may incorporate a valve or device that conforms to ASSE 1016 and/or 1069. Under these performance requirements, ASSE-specified flow ranges, working pressure and/or temperature ranges may apply. In some embodiments, the heating system may meet requirements of the Uniform plumbing Code (UPC) 413.1. For example and in one embodiment, the heating system meets UPC 413.1 when the temperature preset of the liquid at the heating system inlet is properly set so that the resulting water temperature is below 120 degrees Fahrenheit.

In certain embodiments, the thermostatic mixing valve outputs liquid having a temperature between about 90 to 105 degrees Fahrenheit. The heating system may be configured to output liquid at or near specific temperatures, and/or within specific temperature ranges, e.g., anywhere between about 80 degrees Fahrenheit and about 180 degrees Fahrenheit. In one embodiment, the thermostatic mixing valve outputs liquid with a temperature upper limit of about 108 degrees Fahrenheit, although other upper limits, such as about 90, 100, 120, 140 or 180 degrees Fahrenheit, are supported.

As discussed, temperature fluctuations in the heated liquid may exceed the temperature set point T1. In some embodiments, the mixing valve mixes liquid diverted from the inlet with the heated liquid when the temperature of the heated liquid is at least a predefined number of degrees Fahrenheit, D1, above temperature T1. For example, D1 may be set at 2, 3, 5, 10, 15 or 20 degrees Fahrenheit above T1, in various embodiments. In some embodiments, the thermostatic mixing valve outputs liquid at a temperature deviating from T1 by less than about (D1+2) degrees Fahrenheit. By way of example, if D1 is set at 4 degrees Fahrenheit above T1, the mixing valve may output liquid at a temperature deviating from T1 by less than about (4+2)=6 degrees Fahrenheit. In various other embodiments, the thermostatic mixing valve is capable of delivering output liquid at a temperature deviating from T1 by less than about i) (D1+3); ii) (D1+4); iii) (D1+5); iv) (D1+8) degrees Fahrenheit, among other values.

In some embodiments, the extent of the temperature deviation above and below T1 may differ. For example, for an overall temperature deviation of less than about (D1+2) degrees Fahrenheit from T1, a mixing valve may output liquid deviating by up to about (D1+2) degrees Fahrenheit above T1 but up to about 1 degree Fahrenheit below T1. In certain embodiments, the mixing valve may output liquid deviating from zero to (D1+2) degrees Fahrenheit above T1 but not deviating (detectably or significantly) below T1. The mixing valve may pass heated liquid from the heating element to the heating system outlet unchanged in temperature.

The thermostatic mixing valve 778 may output heated or tempered liquid 772 at a flow rate of at least about 0.3 gallons per minute. In various embodiments, and by way of example, the heating system may be configured with one or more mixing valves that outputs heated or tempered liquid 772 at a flow rate of at least about 0.3, 0.5, 0.8, 1.0, 1.5 or 2.0 gpm. The mixing valve 778 may output heated or tempered liquid at a flow rate of about 0.3 gallons per minute to about 5.0 gpm. In one embodiment, and by way of example, the heating system may be configured with a plurality of mixing valves that outputs heated or tempered liquid at about 4.0 gpm in total flow. The flow rate supported by a heating system may depend on the number of heater modules and/or mixing valves, and/or the flow rate supported by each heater module and/or mixing valve.

It should be understood that the systems described above may provide multiple ones of any or each of those components. Therefore, although certain embodiments, including FIGS. 7A and 7B, are described with one heater module and/or mixing valve by way of example, these embodiments are not intended to be limiting in any way. In particular, a heating system can have multiple heater modules 102, such as in the embodiment described in FIG. 1, with the inlet and outlet manifolds adapted to connect to a plurality of heater modules 102 and at least one mixing valve. In addition, certain embodiments of system components are illustratively described as comprising certain structures, dimensions and/or materials, but not intended to be limiting in any way. Equivalent structures, materials and other dimensions are supported and contemplated without departing the scope and spirit of this disclosure.

The claims should not be read as limited to the described order or elements unless stated to that effect. While the invention has been particularly shown and described with reference to specific illustrative embodiments, it should be understood that various changes in form and detail may be made without departing from the spirit and scope of the invention as defined by the appended claims. By way of example, any of the disclosed features can be combined with any of the other disclosed features to a produce an electric tankless liquid heater. Therefore, all embodiments that come within the scope and spirit of the following claims and equivalents thereto are claimed as the invention.

What is claimed is:

1. A tankless liquid heater receiving liquid at an inlet and providing heated liquid at an outlet, comprising:
a heating element for heating liquid received from the inlet of the liquid heater;
a flow sensor indicating the flow rate of the liquid received by the heating element;
a temperature sensor measuring the temperature of liquid exiting the heating element;
a controller regulating the amount of electrical current energizing the heating element responsive to the flow sensor and the temperature sensor, the controller energizing the heating element when the flow rate of the liquid exceeds a predefined value and prevents energizing the heating element when the heated liquid exceeds a predefined temperature, T1; and
a thermostatic mixing valve for mixing the heated liquid with liquid diverted from the inlet responsive to the temperature of the heated liquid.

2. The tankless liquid heater of claim 1 wherein the thermostatic valve mixes liquid diverted from the inlet with the heated liquid when the temperature of the heated liquid is at least a predefined number of degrees Fahrenheit, D1, above temperature T1.

3. The tankless liquid heater of claim 2 wherein the thermostatic mixing valve outputs liquid at a temperature deviating from T1 by less than about (D1+2) degrees Fahrenheit.

4. The tankless liquid heater of claim 1 wherein the thermostatic valve mixes liquid diverted from the inlet with the heated liquid when the temperature of the heated liquid is above a predetermined value.

5. The tankless liquid heater of claim 1 wherein the thermostatic valve mixes liquid diverted from the inlet with the heated liquid when the temperature of the heated liquid is above about 110 degrees Fahrenheit.

6. The tankless liquid heater of claim 1, further comprising an inlet manifold providing liquid from the inlet to the heating element and the thermostatic mixing valve.

7. The tankless liquid heater of claim 1 wherein the thermostatic mixing valve mixes the liquid diverted from the inlet with the heated liquid at a sufficiently fast rate to prevent a person in contact with the mixed water from being scalded.

8. The tankless liquid heater of claim 1 wherein the thermostatic mixing valve diverts a substantial amount of liquid from the inlet within a short amount of time for mixing with the heated liquid responsive to the temperature of the heated liquid.

9. The tankless liquid heater of claim 1 wherein the heating element comprises an electrical resistance heating element.

10. The tankless liquid heater of claim 1 wherein the controller energizes the heating element when the flow rate of the liquid exceeds a predefined value selected from within the range of about 0.3 gallons per minute to 2.0 gallons per minute.

11. The tankless liquid heater of claim 1 wherein the flow sensor comprises a magnetic portion configured to slidably respond to the liquid flow rate in the liquid heater.

12. The tankless liquid heater of claim 1 wherein the controller regulates a switching unit connecting the heating element to a line voltage.

13. The tankless liquid heater of claim 1 wherein the thermostatic mixing valve outputs liquid having a temperature between about 90 to 105 degrees Fahrenheit.

14. The tankless liquid heater of claim 1 wherein the thermostatic mixing valve outputs liquid with a temperature upper limit of about 110 degrees Fahrenheit.

15. The tankless liquid heater of claim 1 wherein the thermostatic mixing valve outputs liquid with a preconfigurable temperature upper limit.

16. The tankless liquid heater of claim 1 wherein the thermostatic mixing valve outputs heated liquid at a flow rate of at least about 0.3 gallons per minute.

17. The tankless liquid heater of claim 1 wherein the thermostatic mixing valve outputs heated liquid at a flow rate of about 0.3 gallons per minute to about 5.0 gallons per minute.

18. The tankless liquid heater of claim 1 wherein the thermostatic mixing valve mixes the heated water with liquid diverted from the inlet when the flow rate of the liquid received by the heating element falls substantially over a short period of time.

19. The tankless liquid heater of claim 1 wherein the thermostatic mixing valve mixes the heated water with liquid diverted from the inlet when the flow rate of the liquid received by the heating element falls substantially instantaneously.

20. The tankless liquid heater of claim 1 wherein the thermostatic mixing valve supports a liquid flow rate equal or higher than that supported by the heating element.
